(19) United States
(12) Patent Application Publication
(10) Pub. No.: US 2007/0255821 A1
(43) Pub. Date: Nov. 1, 2007

(54) Real-time click fraud detecting and blocking system

(76) Inventors: Li Ge, Prospect, KY (US); Mehmed Kantardzic, Louisville, KY (US)

Correspondence Address: Li Ge, 10509 Mountain Ash Ln, Prospect, KY, 40059, US

(21) Appl. No.: 11/413,983

(22) Filed: May 1, 2006

(51) Int. Cl. G06F 15/173

(52) U.S. Cl. 709/224

(57) ABSTRACT

This invention is a real-time system that detects click fraud and blocks those click fraud. This system will be used as an arbitration system to evaluate the quality of every click referred from PPC publishers, thus helping advertiser saving money. The invention uses innovative matching between two logs, client side log and server side log, to find out software click and detect abnormal activities, such as no mouse movement, no mouse clicks, repeat clicks etc. The system includes three parts working cooperatively: a database for logging user click parameter and reporting click fraud, web servers with filter program such as ISAPI filter, CGI or other server side script program, and tracking code inserted to a web page, executed on client computer. The system can also block any fraudulent traffic in real time.

### BACKGROUND

1. Field of Invention

This is a real-time system detects click fraud and blocks the click fraud. It could also be used as an arbitration system to evaluate the quality of every click referred from PPC publishers, thus helping advertiser saving money. This invention can also extend to dynamically block any traffic by setting specific criteria.

2. Description of Related Art

Pay-per-click (PPC) is online advertising payment model, used by search engine companies, in which payment is based solely on qualifying click-throughs. This pay-per-click model is now the fastest-growing form of internet advertising, according to the Interactive Advertising Bureau. However the cost for pay-per-click becomes very high, varying by keywords and list position. An example of a PPC business model is described in U.S. Pat. No. 6,269,361 to Davis, et al.

Click Fraud is a scam involving setting up a website affiliated with a major search engine, displaying pay-per-click advertising from the search engine and then using various methods to fraudulently increase the number of clicks to the advertiser from the affiliate website. The affiliate website receives a portion of the money generated by the click through even though the clicks were not generated by genuine customers. It was identified to be the biggest thread to the internet economy.

Several commercial solutions, e.g. Clicklab, LLC, Web Traffic Intelligence, Inc. etc. are available for click fraud detection. They all use similar technology by adding a sampler or collecting javascript or iframe code on a page to track, and the code will run on the client computer when the page are viewed. Whenever the javascript or iframe is executed on client browser, it sends back information to the logging server. The most common client side parameters include client IP, client user agent, client browser settings, client computer settings, link-out click, user activity etc. FIG. 1 shows the process of commercial click fraud solutions.

### SUMMARY OF THE INVENTION

The invention introduces a new way to detect the major click fraud based on the. collaboration between server side log and client side log. Those two log structure is innovative to detect software clicks. And furthermore, this system can stop click fraud in real time which is distinguished this invention from any other solutions. The architecture is given in FIG. 2.

A searchable database (Global Fraudulent Database, GFD) stores the real-time traffic parameters: the server side log, client side log and a fraud score report data. Server side log is the log entry from web server, which is similar to web log files, including client IP, a tracking ID, client user agent, visited page, referrer source, time stamp and a permanent cookie. Every click request that sends to web server will have an entry in the server side log. Client side log is the data from client browser. A javascript tracking code or iframe is added to each web page. When a client loads a web page, the tracking code will execute on client computer and send client side parameters to the database. The client side log parameters include (a) static parameters: tracking ID, client IP, client user agent, visited page, referrer source, cookies, time stamp, computer display settings, browser settings, page title and (b) dynamic parameters: mouse over activity, mouse click, and scroll bar movement, key strobe, page view time length and clicked link. The server side log and client side log reveal different aspect of a client activity. The tracking IDs are the connection between two logs. The same client web requests log entries in the two entries share the same value. The cookies, session cookie and permanent cookie can identify the same client computer. The click fraud detection methods will identify click fraud based on the two set log data. And a fraudulent score will be given to each web request.

The filter program running on web servers with filter program accomplishes multiple tasks. First the filter sends server side parameters to database GFD. The database GFD logs the server side parameters and sends the fraudulent score back to the filter. The filter will block the client if the fraudulent score is higher than a threshold. If the client web request is normal, the filter will add tracking code to the web page and render the web page to client.

Click fraud is perpetrated in both automated and human ways. The most common method is the use of online robots, or “bots,” programmed to click on advertisers' links that are displayed on Web sites or listed in search queries. Even worse, an ad-ware or spyware may parasite on victim's computer to click on advertisers' link without notifying the host, or popup a soliciting window. A growing alternative employs low-cost workers to click on text links and other ads. Another form of fraud takes place when employees of companies click on rivals' ads to deplete their marketing budgets and skew search results. Based on the data collected by the architecture above, we develop an algorithm to score every click for its quality.

### BRIEF DESCRIPTION OF THE DRAWINGS

FIG. 1 is an exemplary of existing commercial solution for click fraud.

FIG. 2 is the architecture of this real-time click fraud detecting and stopping system.

FIG. 3a is an exemplary of category 1, click fraud in a simply way: a single client clicks PPC links multiple times without viewing the contents.

FIG. 3b is an exemplary of category 1 click fraud: client computer clicks PPC links through proxy server multiple times.

FIG. 4 is an exemplary of category 2 click fraud: software clicks PPC links.

FIG. 5 is an exemplary of category 3 click fraud: spyware, adware or Browser Hijackers send requests to multiple web servers.

FIG. 6(a) is an exemplary of the entry javascript code added to each web page.

FIG. 6(b) is an exemplary of the real javascript code executed on each web page.

FIG. 7 is the Global Fraudulent Database (GFD) Structure.

FIG. 8 is the Software Diagram of the System.

FIG. 9 is the algorithm to calculate fraudulent score.

FIG. 10 is the procedure to update the global fraudulent data set.

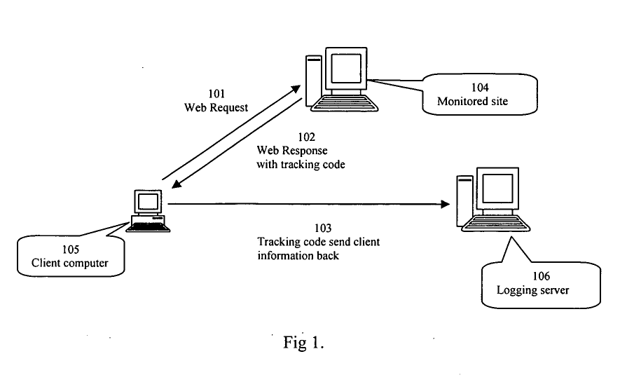

### DETAILED DESCRIPTION

In order to identify click fraud, it is necessary to categorize click fraud by its characters. Different click fraud category will be sensitive to different fraudulent score calculation algorithm. This invention develops fraudulent score calculation algorithm for each type of click fraud.

Click fraud is perpetrated in both automated and human ways. We categorize click fraud into four groups for detection conveniences. They are:

1) Affiliate or Competitor repeat clicking advertisers' site for revenues or competitions:

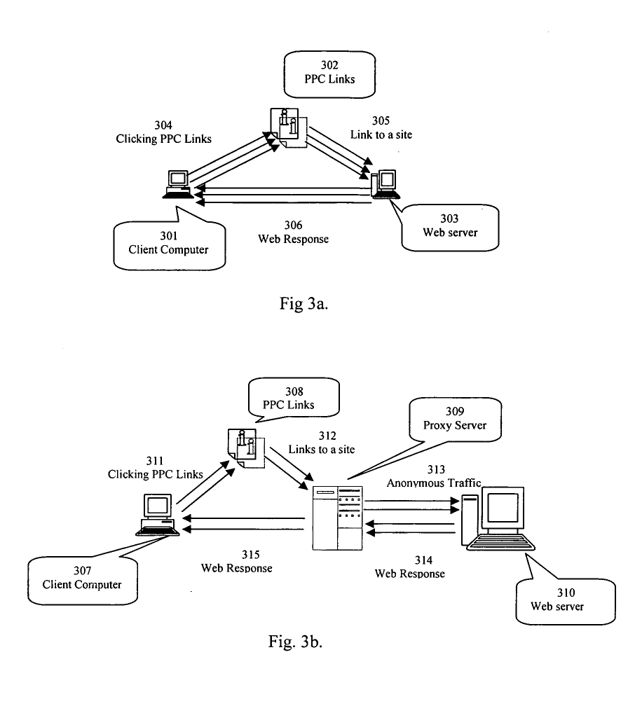

Affiliates set up website to display advertiser's links. Such advertisement links are from different sources, such as google's Adwords, Overture, or company's direct advertisement, etc. The affiliates will be paid on every click on their websites. Then some of them will click on their site's link by themselves to make more money. A company's competitor may click his ad link to drain his marketing fund. This kind of fraud has two characters in common, human activity and specific target site. FIG. 3a illustrates this kind of fraud. This fraud has three steps:
304) A user at client computer 301 clicks a PPC links 302;
305) the links direct 302 to a web server 303;
306) the web server 303 sends the response to client computer 301.

Sometimes people will hide their identity by using anonymous proxy server to click on advertiser's link. FIG. 3b is an anonymous proxy server 309 was set up between the client computer 307 and web server 310. A proxy server 309 is a server sits between application and internet resources, a web server in this case. To this advanced case, there are five steps:
311) A user at client computer 307 clicks a PPC links 308;
312) the links 308 direct to a proxy server 309;
313) the anonymous proxy server 309 hides the original request and redirects the traffic to a web server 310;
314) the web server 310 sends the response to proxy server 309;
315) the proxy server 309 relays the response traffic to client computer 307.

From the web server's point of view, the traffic comes from proxy server instead of client server. If the client switch different proxy server every time clicking the links, the web server will be difficult to find the real origin.

The common character of this kind of fraud is the clicks are generated by human activity without any predictable origination.

2) Software products generating false clicks:

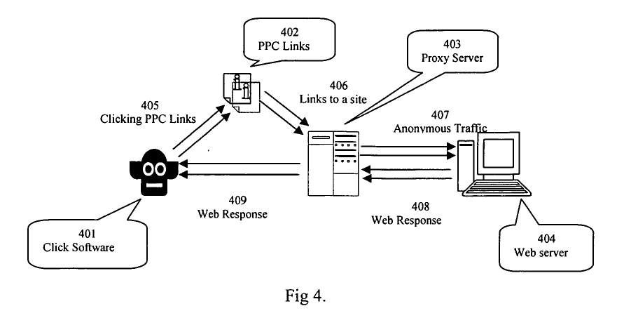

Just like the category 1, software click can connect through an anonymous proxy server too (FIG. 4). The five steps are:
406) Click software 401 clicks a PPC links 402;
407) the links 402 direct to a proxy server 403;
408) the anonymous proxy server 403 hides the original request and redirects the traffic to a web server 404;
409) the web server 404 sends the response to proxy server 403;
410) the proxy server 403 relays the response traffic to click software 401.

There is several click agent software existing on the market. Most of the click agent software on the market has the ability to find free proxy servers and automatically send click traffic through them.

Most of the case, each page load process is not just one request to the web server. Each web page usually contains multiple following requests to the web server, such as pictures, javascript code, music or flash etc. Many click software don't send the following requests to web server. Such character can be a clue to identify software click. Although some good click agent software retrieves the following requests, they are still different with real browser generated traffic by the user detail activities, such as mouse click, mouse movement, key strobe, page view time etc. Most of the case, those user detail activities will be clues to identify software clicks.

This category of click fraud is generated by software without any predictable origination.

3) Adware, Spyware, Browser Hijackers or background links:

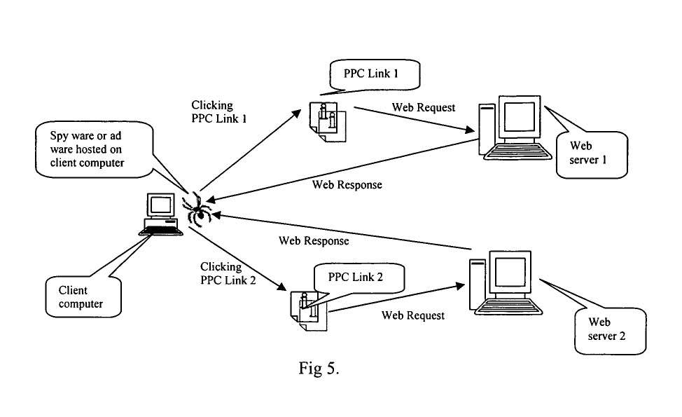

Adware and spyware become a serious problem recently. The software runs on background in the client computer without being known by user. It hijacks browser session and send out web request to multiple ad servers. Such software pop-up an advertise window or sometimes don't pop-up windows at all. FIG. 5 displays the spy ware, adware or browser hijackers installed on client computer sending out web request to make money somehow for a third-party company without the consents of users.

The click fraud in this category is software activity. However, it is different with category 2 software click on that the click fraud is originated from different client computer and the clients' fraudulent activity is passive, which means the click fraud activity are not aware by client user, while the category 2 click fraud are active, which means the client user initiate the fraud. This click fraud category is more difficult to detect than category 2 because, to the server, web traffic looks exactly the same as normal activities. However, client will barely look at the content of the web page. So the user detail activity of this kind of fraud, such as mouse click, key strobe, view time etc., will be less than that of normal user.

4) People in developing countries or university kids click on ads to make money:

This kind of click fraud has some similarity with category 1, that is, it is human activity. However, it is different with category 1, which the fraudulent traffic IP may or may not from susceptible location, e.g. developing country, university etc. And the category 4 traffic IP is from susceptible location. Since we know each county or organizations IP block, class B or class C IP block, we can flag some traffic if the click are from some highly susceptible location. Click time can be another indicator of this kind of click fraud. For example, if a lot of traffic is from one IP block location on susceptible time, such as late night local time, the possibility of click fraud will be higher than other traffic.

Hardware Architechure of the Invention

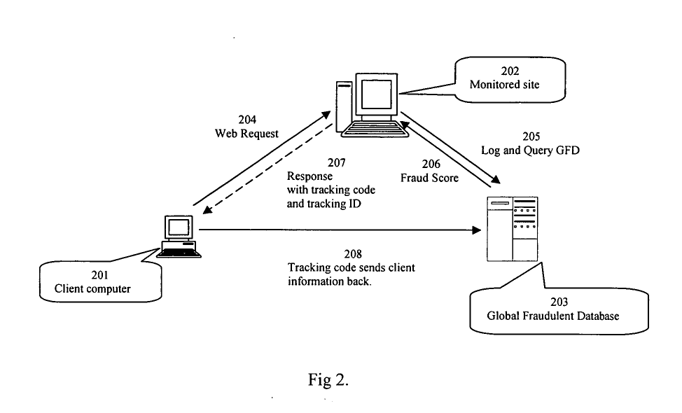

This invention will be able to detect the four category click fraud listed above by using the architecture introduced in FIG. 2. The three parts of this invention are:
203 Global Fraudulent Database (GFD) which stores the server side log, client side log and a fraud score report data; 202 monitored web server with filter program; 201 Client computer which could be normal user, click fraud user or software.

There are 5 steps in logging and blocking process.
204 Client computer 201, which could be possible fraudulent computer, sends web request to a web server 202;
205 the web server with filter program sends server side data to GFD 203; The log data includes a tracking ID, Client IP, Client User Agent, Visited Page, Referrer Source, Time Stamp and two Cookies, a Session Cookie and a Permanent Cookie;
206 GFD 203 logs the sever side data and return Fraud Score to web server 202;
207 web server 202 sends back response with tracking code to client computer 201 under the following condition: A) If the returned fraud score is higher than a threshold designated by customer, web server will block the web request and send a warning page instead; B) If the fraud score is lower than the threshold, the server will send the page with javascript tracking code back to client computer;
208 the tracking code executes on client computer 201 and keeps sending client side log back to GFD 203; The javascript tracking code will send GFD 203 both static and dynamic parameters. The static parameters include tracking ID, Client IP, Client User Agent, Visited Page, Referrer Source, Cookies, Time Stamp, Display Settings, Brower Settings, Page Title and the dynamic parameters include Mouse Over, Mouse Click, Scroll Bar Movement, Key Strobe and Clicked Link.

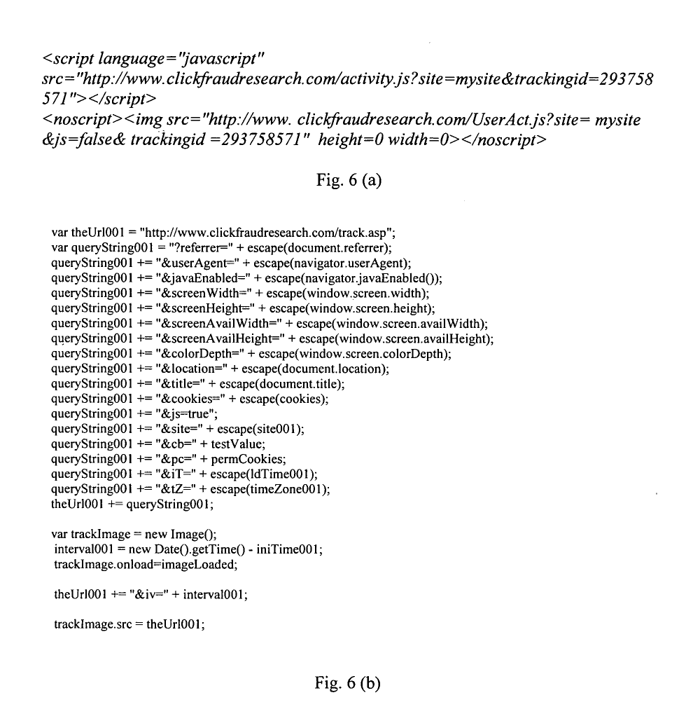

Most of the parameters in 205 are defined in Hypertext Transfer Protocol—HTTP/1.1 (RFC 2616). We added two extra cookies and a tracking ID besides the RFC header for tracing purpose. A permanent cookie is the cookie we implant to client computer with expire date 1 year and a session cookie will be expired whenever the client close the connection session. We use those two cookies to identify client computers. Whenever the client computer connect to the same web site, the client permanent cookie will be send to web server as a part of the web request. A tracking ID will be added to the javascript code and send to client. The tracking code inside every page looks as in FIG. 6(a).

The number 29375857 in FIG. 6(a) is tracking ID. The purpose of this tracking id is to match the client side log with is corresponding server side log. By using this match, we will be able to detect category 2 fraud. In step 208, when the javascript code executes on client side, it will collect the client side setting and log to GFD 203.

We will have a detail example to illustrate how the logging works. Suppose user A open a browser and navigate to site www.mysite.com, the web browser send the web request defined in HTTP 1.1 to site www.mysite.com. Site www.mysite.com sends the web request parameters along with serialized tracking ID to GFD. GFD returns a fraud score S back to site www.mysite.com. If the fraud score S is less than a threshold value, site www.mysite.com sends the requested page and the tracking code above to client browser. The client browser will display the page, and at the same time the above tracking code will execute on user A's browser and report A's activity to GFD. Since the same tracing ID appears in the two logs, it reveals the two log entries are connected.

Among these five steps, two steps, 205 and 208, are data collecting phase. Those two steps distinct our solution with current commercial solutions, which are step 208 only, and the research approaches, which are focusing on web log, equivalent to step 205.

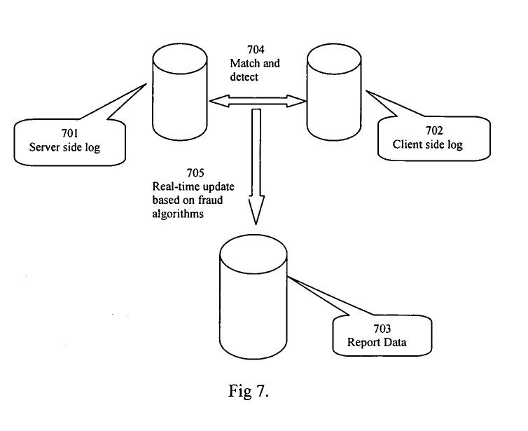

The core part of this system is the Global Fraud Database (GFD), which stores the real-time server side log 701, client side log 702 and a fraud score report data 703 (FIG. 7.). The fraud score report data 703 is not based on isolated source, such as a single web site. It is based on a global data collected. The more data collected, the more accurate the score will be.

Software Diagram of the Invention

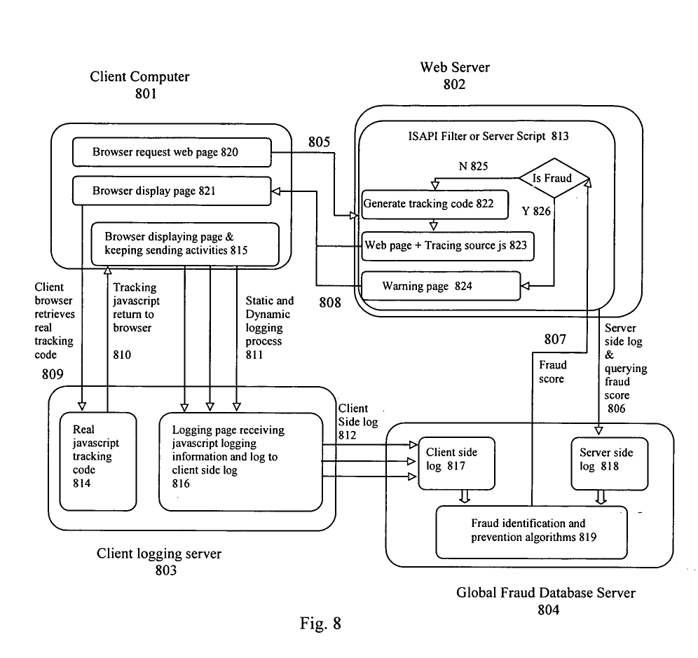

FIG. 8 gives the software realization of the system. The software system consists of a four collaborative parts, which using javascript, C++ ISAPI filter or other Server Script such as ASP, PHP etc, ASP log pages, Transactional SQL query. FIG. 8 shows the software diagram of the system.

The four blocks are:
801 Client Computer block (residents on client computer 201 in FIG. 2); the software in this block is web browser or other software crawlers.
802 Web server block (residents on monitored site 202 in FIG. 2); the software used in this block is ISAPI filter or other Server Script such as ASP, PHP etc.
803 Client logging server; this block uses Javascript 814 and Server Script 815. This is an auxiliary block which is not listed on FIG. 2.
804 Global Fraud Database (GFD) (residents on Global Fraud Database 203); the software used in this block is SQL query.

The detailed software process is listed as followings:
805 When a user/frauder opens a browser/software and browser to a site, the request reaches ISAPI filter/Server Script 813.
806 The Filter/Server Script 813 logs server side log 818 to GFD 804 and query GFD 804 for fraud score.
807 A fraud score is returned to the filer 813.
825 If the score is less than a threshold, the request is good. Server will generate tracking code 822 and appends it to the page 823. If the score is higher than a threshold, the request is fraud. A warning page is generated 824. The javascript code is displayed in FIG. 6.
808 The page is returned to browser 821.
*809 The tracking code is retrieved from real location 814. This step is optional.
*810 The real javascript tracking code is sending to the page. This step is optional. FIG. 6(b) is an exemplary real tracking code used in this system.
811 Since javascript can't log to a database by itself, the javascript keep sending dynamic logs to a server script page 816 to log.
812 The server script keep logging to Client side log 817.
   *809 and 810 are optional. If the real tracking code is rendered in 822, those two steps are omitted.
   Click Fraud Determinations

By using the architecture above, we use the following method to calculate click fraud score. The fraud score is our fraudulent detection system output, which is the function of request's IP, referrer source, user agent, permanent cookie, page view time length, user activities and other non significant parameters S=f(IP, R, U, C, T, A,TrID, O), S stand for fraud score, IP is request's IP and R is the referrer parameters, U is the user agent, C is the permanent cookie, T is the page view time length, A is the user activities, Trid is the tracking ID and O is other non significant parameters, which are browser setting, page load time, link out click etc. Different fraud category is sensitive to different parameters. At the same time, we keep several global fraudulent data sets for different parameter, e. g. a global fraudulent IP data Fᵢₚ, a global fraudulent referrer data Fᵣ and a global fraudulent User Agent data F_{U}.

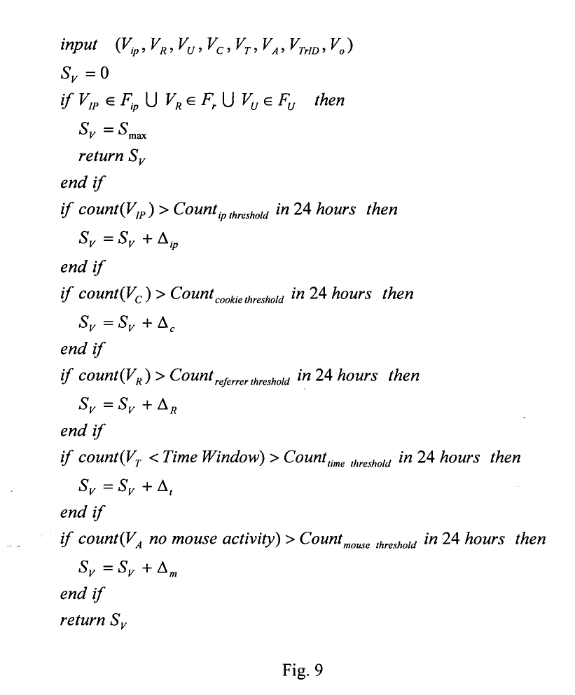

FIG. 9 illustrates the fraud calculation process. We initialize the fraud score S_{V} to 0 and set the input vector as (Vᵢₚ, V_{R}, V_{U}, V_{C}, V_{T}, V_{A}, V_{TrID}, V_{O}). We check the input vector against global fraudulent data sets, Fᵢₚ, Fᵣ, and F_{U}. If the individual item IP, Referrer and User Agent is inside the data set, we identify this click as fraud then return the maximum fraud score Sₘₐₓ. In FIG. 9, Count_{ip threshold} is a heuristic ip count threshold constant number. Δᵢₚ is the fraud score increase if the count of an ip exceeds the threshold. For example, if Count_{ip threshold}=100, and the count of the same ip during the past 24 hours greater than 100, the fraud score will increase Δᵢₚ. Count_{cookie threshold} is a heuristic permanent cookie count threshold constant number. Δ_{c} is the fraud score increase if the count of a permanent cookie exceeds the threshold. Count_{referrer threshold} is a heuristic referrer count threshold constant number. Δ_{R} is the fraud score increase if the count of referrer exceeds the threshold. Count_{time threshold} is a heuristic page view time threshold constant number. Δₜ is the fraud score increase if the count of referrer exceeds the threshold. Count_{mouse threshold} is a heuristic mouse activity threshold constant number. Δm is the fraud score increase if the count of referrer exceeds the threshold. All of accumulated count numbers are based on 24 hours period.

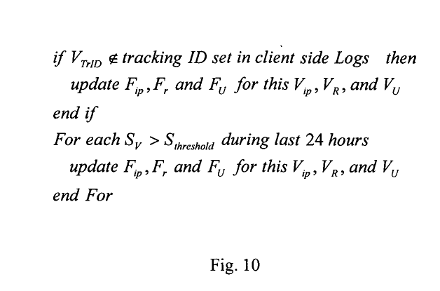

During the end of every day, we update the global fraudulent data base as displayed in FIG. 10. We update the Fᵢₚ, Fᵣ, and F_{U} data set based on two conditions: 1) check the software click, that is, if a TrID is in server side log, but not in client side log, this click is a software click fraud; 2) for every identified click fraud during the past day, we update the Fᵢₚ, Fᵣ, and F_{U} for this click.

We claim:

1. A real-time click fraud detecting and blocking system comprising: at least one database; plurality web sites with ISAPI filter or server side script program; client user activity tracking code; an algorithm to identify click fraud by generating fraudulent score;

2. the real-time click fraud detecting and blocking system of claim 1 wherein said database storing client side log, server side log;

3. the real-time click fraud detecting and blocking system of claim 1 wherein said web servers with filter program or server side script sending the server side log to said database, querying said database for fraudulent score, and conditionally blocking traffic based on said fraudulent score, inserting said tracking code to web pages;

4. the real-time click fraud detecting and blocking system of claim 1 wherein said user activity tracking code executing on client computer and keeping sending client side log to the said database, and the tracking code can be, but not limited to, javascript code or iframe;

5. the said server side log of claim 2 is generated by said web sites with filter or server side script program of claim 1;

6. the said server side log of claim 2 further including a tracking ID, web request client IP, client user agent, visited page, referrer source, time stamp, permanent cookie;

7. the said permanent cookie of claim 6 is set with expiration duration longer than a month to identify the same client computer;

8. the said client side log of claim 2 is generated by said tracking code of claim 1 running on any client computer visiting the said web sites of claim 1;

9. the said client side log of claim 2 further including (a) static parameters: tracking ID, client IP, client user agent, visited page, referrer source, time stamp, computer display settings, browser settings, page title and (b) dynamic parameters: mouse over activity, mouse clicks, and scroll bar movement, key strobe, page view time length and clicked link;

10. the said tracking ID of claim 6 and claim 9 is an unique identification number generated by said filter or server side script program of claim 1;

11. the said tracking ID of claim 6 and claim 9 refer to the same content which is used to match the client side log and server side log of claim 2;

12. the said blocking traffic based on said fraudulent score of claim 3 means that if the said fraudulent score is higher than a threshold, the filter or server side script program will not render the page to client;

13. the said inserting said tracking code to web pages of claim 3 means that if the said filter or server side script program allows the web page sending to client computer, the said tracking code is insert into this web page to detect the said client side log;

14. the algorithm to generate the fraudulent score of claim 1 comprising: matching said client side log and said server side log by using said tracking ID; counting said client IP reoccurrence in a short time period; identifying suspicious referrer source; monitoring non-activity of said client side log; monitoring said page view time length; monitoring IP locations; monitoring page view time stamps;

15. the said non-activity of said client side log of claim 16 including no activities of said mouse over activity of claim 9;

16. the said non-activity of said client side log of claim 16 including no activities of said mouse click of claim 9;

17. the said non-activity of said client side log of claim 16 including no activities of said scroll bar movement of claim 9;

18. the said non-activity of said client side log of claim 16 including no activities of said key strobe of claim 9;

19. the said non-activity of said client side log of claim 16 including no activities of said clicked link of claim 9.
